(19) United States
(12) Patent Application Publication
(10) Pub. No.: US 2026/0235040 A1
(43) Pub. Date: Aug. 13, 2026

(54) TURBINE AND TURBOCHARGER

(71) Applicant: MITSUBISHI HEAVY INDUSTRIES ENGINE & TURBOCHARGER, LTD., Sagamihara-shi, Kanagawa (JP)

(72) Inventors: Keigo SAKAMOTO, Tokyo (JP); Takashi ARAI, Tokyo (JP); Kimiya SAKAGUCHI, Sagamihara-shi (JP); Makoto OZAKI, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/160,790

(22) PCT Filed: Mar. 30, 2023
(86) PCT No.: PCT/JP2023/013359

§ 371 Date: Aug. 28, 2025

(51) Int. Cl. F01D 9/04; F01D 25/24; F02B 39/00

(52) U.S. Cl. CPC F01D 9/041; F01D 25/24; F02B 39/00

(57) ABSTRACT

This turbine comprises: a turbine wheel; a first housing having a scroll flow path; a second housing that accommodates the turbine wheel between the first housing and the second housing, and forms a gas flow path from the scroll flow path toward the turbine wheel; a nozzle device including at least an annular first plate part and at least one fixed nozzle vane, the annular first plate part having a first flow path surface facing the gas flow path, and a first back surface that is a surface on the opposite side in the axial direction of the turbine wheel from the first flow path surface, and that forms a first space between the first housing and the second housing, the fixed nozzle vane being fixed to or supported on the first plate part and extending along the axial direction in the gas flow path; and a biasing member that is disposed in the first space and configured to bias at least one fixed nozzle vane toward the first housing via the first plate part.

### TECHNICAL FIELD The present disclosure relates to a turbine and a turbocharger.

### BACKGROUND ART

In a turbine of a turbocharger, there is a case where a fixed nozzle is disposed in a gas flow path from a scroll flow path toward a turbine wheel. PTL 1 discloses a support structure in which a fixed nozzle is integrated with an annular nozzle ring that supports the fixed nozzle and the fixed nozzle is supported by clamping an outer peripheral end portion of the nozzle ring by a turbine casing and a bearing pedestal.

### CITATION LIST

### Patent Literature

[PTL 1] Japanese Unexamined Patent Application Publication No. 2015-110924

### SUMMARY OF INVENTION

### Technical Problem

In the nozzle ring, the outer peripheral end portion is in contact with the bearing pedestal having a relatively low temperature, whereas an inner peripheral end portion is exposed to an exhaust gas having a relatively high temperature. In this way, relatively high thermal stress is generated in the nozzle ring due to temperature distributions generated on the inner and outer peripheries of the nozzle ring, and thus there is a concern that thermal fatigue damage may be caused to the nozzle ring.

Meanwhile, a spring member that supports the nozzle ring may be disposed in the turbine. However, the spring member may not follow a change in temperature of the exhaust gas that is introduced into the turbine, and a biasing force of the spring member may not act on the nozzle ring.

In view of the above circumstances, an object of at least one embodiment of the present disclosure is to provide a turbine and a turbocharger, in which it is possible to continuously support a nozzle device during an operation of a turbine and to reduce thermal stress that is generated in the nozzle device.

### Solution to Problem

A turbine according to at least one embodiment of the present disclosure includes:
a turbine wheel;
a first housing having a scroll flow path;
a second housing that is connected to the first housing, accommodates the turbine wheel between the first housing and the second housing, and forms a gas flow path from the scroll flow path toward the turbine wheel between the first housing and the second housing;
a nozzle device including at least
   an annular first plate portion having a first flow path surface facing the gas flow path, and a first back surface that is a surface on a side opposite to the first flow path surface in an axial direction of the turbine wheel and that forms a first space between the first housing and the second housing, and
   at least one fixed nozzle vane fixed to or supported by the first plate portion and extending along the axial direction in the gas flow path; and
a biasing member disposed in the first space and configured to bias the at least one fixed nozzle vane toward a first housing side via the first plate portion.

A turbocharger according to at least one embodiment of the present disclosure includes:
the turbine described above; and
a centrifugal compressor configured to be driven by the turbine.

### Advantageous Effects of Invention

According to at least one embodiment of the present disclosure, there are provided a turbine and a turbocharger, in which it is possible to continuously support a nozzle device during an operation of a turbine and to reduce thermal stress that is generated in the nozzle device.

### BRIEF DESCRIPTION OF DRAWINGS

FIG. 1 is a schematic sectional view taken along an axis of a turbine according to one embodiment of the present disclosure.

FIG. 2 is a schematic diagram of a nozzle device of the turbine according to one embodiment of the present disclosure, as viewed from one side in an axial direction.

FIG. 3 is a schematic sectional view taken along an axis of a turbine according to a comparative example.

FIG. 4 is an explanatory diagram for explaining a temperature change of a working fluid that is introduced into the turbine according to one embodiment of the present disclosure.

FIG. 5 is an explanatory diagram for explaining a change in a biasing force that is applied to a nozzle device of the turbine according to the comparative example.

FIG. 6 is an explanatory diagram for explaining a change in a biasing force that is applied to the nozzle device of the turbine according to one embodiment of the present disclosure.

FIG. 7 is a schematic sectional view taken along the axis of the turbine according to one embodiment of the present disclosure.

FIG. 8 is a schematic sectional view taken along the axis of the turbine according to one embodiment of the present disclosure.

FIG. 9 is a schematic sectional view taken along the axis of the turbine according to one embodiment of the present disclosure.

FIG. 10 is a schematic sectional view taken along the axis of the turbine according to one embodiment of the present disclosure.

FIG. 11 is a schematic sectional view taken along the axis of the turbine according to one embodiment of the present disclosure.

FIG. 12 is a schematic diagram of a turbocharger according to one embodiment of the present disclosure.

### DESCRIPTION OF EMBODIMENTS

Hereinafter, some embodiments of the present disclosure will be described with reference to the accompanying drawings. Dimensions, materials, shapes, relative arrangements, and the like of components described as embodiments or illustrated in the drawings are not intended to limit the scope of the present disclosure, but are merely explanatory examples.

### Turbine

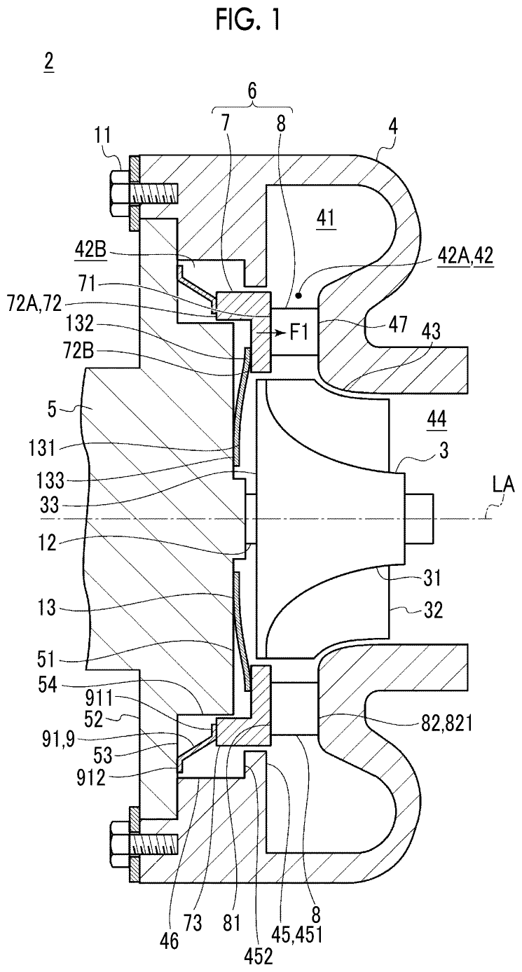

FIG. 1 is a schematic sectional view taken along an axis LA of a turbine 2 according to one embodiment of the present disclosure. As shown in FIG. 1, the turbine 2 according to some embodiments includes a turbine wheel 3, a first housing (a turbine housing) 4 having a scroll flow path 41, a second housing (a bearing housing) 5, a nozzle device 6, and a biasing member 9. The second housing 5 is connected to the first housing 4 via a fastening member such as a bolt 11, for example, and is configured to accommodate the turbine wheel 3, the nozzle device 6, and the biasing member 9 between the first housing 4 and the second housing 5. In addition, the second housing 5 is configured to form a gas flow path 42A that guides a gas from the scroll flow path 41 toward the turbine wheel 3 between the first housing 4 and the second housing 5.

Hereinafter, a direction in which the axis LA of the turbine wheel 3 extends is defined as an axial direction of the turbine wheel 3, a direction orthogonal to the axis LA is defined as a radial direction of the turbine wheel 3, and a circumferential direction around the axis LA is defined as a circumferential direction of the turbine wheel 3. In the present disclosure, the axial direction, the radial direction, and the circumferential direction of the turbine wheel 3 may be simply referred to as an axial direction, a radial direction, and a circumferential direction. A side (a right side in FIG. 1) on which the first housing 4 is located with respect to the second housing 5 in the axial direction of the turbine wheel 3 is defined as a front side, and a side (a side opposite to the front side, a left side in FIG. 1) on which the second housing 5 is located with respect to the first housing 4 is defined as a rear side. In the present disclosure, the expression “along a certain direction” includes not only a certain direction but also a direction inclined within a range of ±15°with respect to the certain direction.

### Turbine Wheel

The turbine wheel 3 is configured to guide a gas (for example, an exhaust gas discharged from an internal combustion engine (not shown) or a fuel cell (not shown)) that is introduced from an outer side in the radial direction to the front side along the axial direction.

As shown in FIG. 1, the turbine wheel 3 includes a hub 31 having a substantially frustoconical shape, and a plurality of turbine blades 32 provided on an outer peripheral surface of the hub 31. The plurality of turbine blades 32 are disposed at intervals in the circumferential direction around the axis LA. The hub 31 is mounted on one side of a rotating shaft 12. The hub 31 and the plurality of turbine blades 32 are rotatable integrally with the rotating shaft 12 around the axis LA. The turbine wheel 3 and the rotating shaft 12 are rotatably supported by the second housing 5. Each of the plurality of turbine blades 32 is disposed with a predetermined gap with respect to a shroud surface 43 that is an inner surface of the first housing 4. In the illustrated embodiment, the turbine wheel 3 is configured with an open-type impeller that does not include an annular member surrounding an outer periphery of the turbine blade 32.

### Scroll Flow Path and Gas Discharge Flow Path

The above-described scroll flow path 41 for guiding a gas for rotating the turbine wheel 3 to the turbine wheel 3 and a gas discharge flow path 44 for discharging the gas that has passed through the turbine wheel 3 to the outside of the first housing 4 (the turbine 2) are formed inside the first housing 4. The scroll flow path 41 is provided on an outer periphery side (an outer side in the radial direction) of the turbine wheel 3, and is configured with a spiral flow path extending along the circumferential direction to surround the turbine wheel 3. The gas discharge flow path 44 extends toward the front side along the axial direction.

The first housing 4 and the second housing 5 are fastened to each other, so that an internal space 42 connecting the scroll flow path 41 and the gas discharge flow path 44 is formed between the first housing 4 and the second housing 5. The turbine wheel 3 is accommodated in the internal space 42 to be rotatable with respect to the first housing 4 and the second housing 5. The turbine wheel 3 is disposed on an inner periphery side (an inner side in the radial direction) of the scroll flow path 41.

The gas, which is a working fluid of the turbine 2, is guided from the outside of the turbine 2 to the turbine wheel 3 via the scroll flow path 41, and rotationally drives the turbine wheel 3. The working fluid that has rotationally driven the turbine wheel 3 is discharged to the outside of the turbine 2 via the gas discharge flow path 44.

### Nozzle Device

As shown in FIG. 1, the nozzle device 6 includes at least an annular first plate portion 7 and at least one fixed nozzle vane 8 fixed to or supported by the first plate portion 7 and extending along the axial direction in the gas flow path 42A. The nozzle device 6 is accommodated in the internal space 42, so that the gas flow path 42A described above is formed.

### First Plate Portion

The first plate portion 7 is configured to form the gas flow path 42A from the scroll flow path 41 toward the turbine wheel 3 between the first plate portion 7 and another member (the first housing 4 in FIG. 1). The gas flow path 42A is provided between the scroll flow path 41 and the turbine wheel 3 in the radial direction to surround the outer periphery side of the turbine wheel 3. The gas flow path 42A is a part of the internal space 42 and is formed on an outer periphery side with respect to an accommodation space for accommodating the turbine wheel 3 in the internal space 42. The first plate portion 7 is located on the rear side with respect to the gas flow path 42A.

As shown in FIG. 1, the first plate portion 7 has an annular first flow path surface 71 facing the gas flow path 42A on one side in a thickness direction of the first plate portion 7, that is, on the front side. The first plate portion 7 has an annular first back surface 72 on the other side (a side opposite to the first flow path surface 71) in the thickness direction of the first plate portion 7, that is, on the rear side.

### Fixed Nozzle Vane

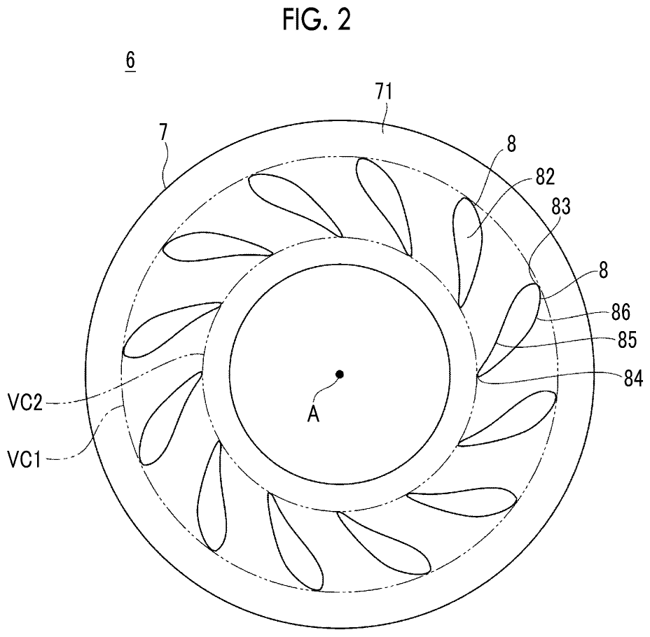

FIG. 2 is a schematic diagram of the nozzle device 6 of the turbine 2 according to one embodiment of the present disclosure, as viewed from the front side which is one side in the axial direction. In the illustrated embodiment, as shown in FIGS. 1 and 2, the at least one fixed nozzle vane 8 described above includes a plurality of fixed nozzle vanes 8 disposed at intervals in the circumferential direction of the turbine wheel 3. In the illustrated embodiment, the plurality of fixed nozzle vanes 8 are fixed to the first plate portion 7 and protrude from the first flow path surface 71 toward the first housing 4 side (the front side).

In the embodiment shown in FIGS. 1 and 2, each of the plurality of fixed nozzle vanes 8 is formed integrally with the first plate portion 7, and an end portion thereof on one side (the rear side) in the axial direction is connected to the first flow path surface 71. In this way, each of the plurality of fixed nozzle vanes 8 is fixed to the first flow path surface 71. Each of the plurality of fixed nozzle vanes 8 includes a front-side end surface 821 formed at an end portion 82 on the side (front side) opposite to an end portion 81 on the one side that is connected to the first plate portion 7, a leading edge 83, a trailing edge 84, and an inner vane surface 85 and an outer vane surface 86 each extending from the leading edge 83 to the trailing edge 84.

In each of the plurality of fixed nozzle vanes 8, the trailing edge 84 is provided on the inner side in the radial direction with respect to the leading edge 83. In each of the plurality of fixed nozzle vanes 8, a vane surface facing the gas flow path 42A is configured with the leading edge 83, the trailing edge 84, the inner vane surface 85, and the outer vane surface 86.

In the embodiment shown in FIG. 1, the first housing 4 has a housing-side flow path surface 47 extending from the outer peripheral end of the shroud surface 43 toward the outer side in the radial direction. The housing-side flow path surface 47 extends along the circumferential direction and is configured with an annular surface facing the gas flow path 42A. The housing-side flow path surface 47 is located on the front side with respect to the first flow path surface 71 of the first plate portion 7 in the axial direction, and faces the first flow path surface 71 with the gas flow path 42A interposed therebetween. The gas flow path 42A is formed by the first flow path surface 71 and the housing-side flow path surface 47.

In the embodiment shown in FIG. 1, in each of the plurality of fixed nozzle vanes 8, the front-side end surface 821 abuts against the housing-side flow path surface 47.

### First Space

The first back surface 72 of the first plate portion 7 is configured to form a first space 42B between the first housing 4 and the second housing 5. In the illustrated embodiment, the second housing 5 is disposed on the rear side with respect to the turbine wheel 3 and the first plate portion 7.

In the illustrated embodiment, the second housing 5 has an end surface 51 on the first housing 4 side (the front side), and an outward protrusion portion 52 that protrudes to the outer side in the radial direction from an outer edge of the end surface 51 on the rear side of the end surface 51. Each of the end surface 51 and a stepped surface 53, which is an end surface on the front side of the outward protrusion portion 52, is configured with an annular surface extending along the circumferential direction. The second housing 5 has an outer peripheral surface 54 that extends from the outer edge of the end surface 51 toward the rear side along the axial direction and that is connected to an inner edge of the stepped surface 53.

In the illustrated embodiment, the first housing 4 has a rear-side scroll flow path surface 451 facing the rear side of the scroll flow path 41, and has an inward protrusion portion 45 extending toward the inner side in the radial direction along the radial direction. The first housing 4 has an inner peripheral surface 46 extending along the circumferential direction on the rear side with respect to the inward protrusion portion 45. The inner peripheral surface 46 faces the outer peripheral surface 54 with a gap interposed therebetween in the radial direction.

The inward protrusion portion 45 has an annular surface 452 extending along the circumferential direction on a side opposite to the rear-side scroll flow path surface 451 in the thickness direction, that is, on the rear side. The annular surface 452 extends from the front end of the inner peripheral surface 46 toward the inner side in the radial direction, and faces the stepped surface 53 with a gap interposed therebetween in the axial direction.

In the illustrated embodiment, the first plate portion 7 is disposed on the inner side in the radial direction with respect to the inward protrusion portion 45. The first back surface 72 of the first plate portion 7 includes a first outer periphery-side back surface 72A that faces the stepped surface 53 with a gap interposed therebetween in the axial direction, and a first inner periphery-side back surface 72B that faces the end surface 51 with a gap interposed therebetween in the axial direction. The first outer periphery-side back surface 72A is an end surface on the rear side of a rear-side protrusion portion 73 that protrudes to the rear side with respect to the first inner periphery-side back surface 72B on the outer side in the radial direction with respect to the first inner periphery-side back surface 72B. The first outer periphery-side back surface 72A is located on the rear side with respect to the end surface 51.

The first space 42B described above is formed by the first outer periphery-side back surface 72A of the rear-side protrusion portion 73 of the first plate portion 7, the annular surface 452 and the inner peripheral surface 46 of the first housing 4, and the stepped surface 53 and the outer peripheral surface 54 of the second housing 5. The first space 42B is surrounded by the first plate portion 7, the first housing 4, and the second housing 5, so that it is difficult for the heat of a gas that is introduced into the turbine wheel 3 to flow into the first space 42B, compared to the gap between a back surface 33 of the turbine wheel 3 and the end surface 51 of the second housing 5 or the gas flow path 42A.

### Biasing Member

As shown in FIG. 1, the biasing member 9 is disposed in the first space 42B and is configured to bias at least one fixed nozzle vane 8 toward the first housing 4 side via the first plate portion 7.

In the illustrated embodiment, the biasing member 9 is an annular elastic member disposed in a state of being compressed in the axial direction between the stepped surface 53 of the second housing 5 and the first outer periphery-side back surface 72A of the first plate portion 7. The stepped surface 53 receives a reaction force of the biasing member 9, so that the biasing member 9 biases the first outer periphery-side back surface 72A toward the first housing 4 side (the front side). The biasing force of the biasing member 9 that biases the nozzle device 6 is set to be F1. The nozzle device 6 is supported between the biasing member 9 and the first housing 4 in the axial direction by the biasing force F1 of the biasing member 9.

The first housing 4 is configured such that only the housing-side flow path surface 47 restricts the movement of the nozzle device 6 along the axial direction. The nozzle device 6 is in contact with the biasing member 9 and is configured such that even when the nozzle device 6 moves along the axial direction by the biasing force F1 of the biasing member 9, the movement is not restricted by the inward protrusion portion 45.

The biasing force F1 preferably acts on a radial position as close as possible to the radial position where the fixed nozzle vane 8 is present, and more preferably acts on the radial position. As shown in FIG. 2, a virtual circle that passes through the leading edges 83 of the plurality of fixed nozzle vanes 8 located on an outermost side in the radial direction with an axial center A of the nozzle device 6 as an origin is defined as an outer periphery-side virtual circle VC1, and a virtual circle that passes through the trailing edges 84 of the plurality of fixed nozzle vanes 8 located on an innermost side in the radial direction with the axial center A as an origin is defined as an inner periphery-side virtual circle VC2. The radial position where the fixed nozzle vane 8 described above is present means a position on the inner side in the radial direction with respect to the outer periphery-side virtual circle VC1 and the outer side in the radial direction with respect to the inner periphery-side virtual circle VC2.

### Heat Shielding Member

As shown in FIG. 1, the turbine 2 according to some embodiments further includes a heat shielding member (a back plate) 13 having a first facing surface 131 that faces the back surface 33 of the turbine wheel 3 with a gap interposed therebetween in the axial direction. The heat shielding member 13 has a first plate portion-side abutment portion 132 that abuts against the first plate portion 7 on an outer periphery side with respect to the first facing surface 131, and a second housing-side abutment portion 133 that abuts against the second housing 5.

In the illustrated embodiment, the heat shielding member 13 is formed in an annular shape in which the first plate portion-side abutment portion 132 abuts against the first inner periphery-side back surface 72B and the second housing-side abutment portion 133 abuts against the end surface 51 on an inner periphery side with respect to the first plate portion-side abutment portion 132. The heat shielding member 13 is inclined to the rear side toward the inner peripheral end portion from the outer peripheral end portion. The heat shielding member 13 is an annular disc spring disposed in a state of being compressed in the axial direction between the first inner periphery-side back surface 72B and the end surface 51. The end surface 51 receives a reaction force of the heat shielding member 13, so that the heat shielding member 13 biases the first inner periphery-side back surface 72B toward the first housing 4 side (the front side). The biasing force of the heat shielding member 13 preferably acts on a radial position as close as possible to the radial position where the fixed nozzle vane 8 is present, and more preferably acts on the radial position.

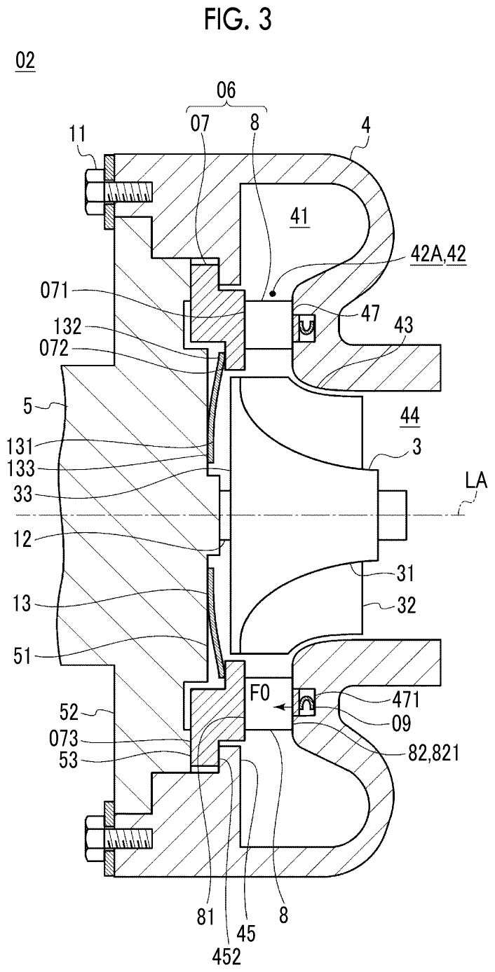

FIG. 3 is a schematic sectional view taken along the axis LA of a turbine 02 according to a comparative example. As shown in FIG. 3, the turbine 02 according to the comparative example includes the turbine wheel 3, the first housing 4, the second housing 5, and the heat shielding member (back plate) 13 described above. The turbine 02 further includes a nozzle device 06 that includes an annular nozzle ring 07 and a plurality of fixed nozzle vanes 8 fixed to the nozzle ring 07. The turbine 02 includes an annular seal ring 09 instead of the biasing member 9.

The nozzle ring 07 has an annular first flow path surface 071 facing the gas flow path 42A, and an annular first back surface 072 provided on a side opposite to the first flow path surface 071 of the first plate portion 7. An outer peripheral end portion 073 of the nozzle ring 07 is clamped by the inward protrusion portion 45 of the first housing 4 and the outward protrusion portion 52 of the second housing 5, and the deformation thereof is suppressed. The outer peripheral end portion 073 is in contact with the second housing 5 having a relatively low temperature. In contrast, an inner peripheral end portion of the nozzle ring 07 is exposed to a working fluid (for example, an exhaust gas that is discharged from an engine 15) having a relatively high temperature. In this way, due to temperature distributions occurring on the inner and outer peripheries of the nozzle ring 07, relatively high thermal stress is generated in the nozzle ring 07, and thus there is a concern that thermal fatigue damage may occur in the nozzle ring 07.

In order to adopt a structure in which the outer peripheral end portion 073 of the nozzle ring 07 is clamped by the inward protrusion portion 45 and the outward protrusion portion 52, it is necessary to increase the outer diameter of the nozzle ring 07, and thus there is a concern that component costs may increase.

In the turbine 02 according to the comparative example, the annular seal ring 09 inserted into an annular recessed portion 471 formed on the housing-side flow path surface 47 biases the plurality of fixed nozzle vanes 8 toward the rear side in the axial direction of the turbine wheel 3 via an annular plate that abuts against the plurality of fixed nozzle vanes 8. A biasing force of the annular seal ring 09 that biases the nozzle ring 07 is set to be FO.

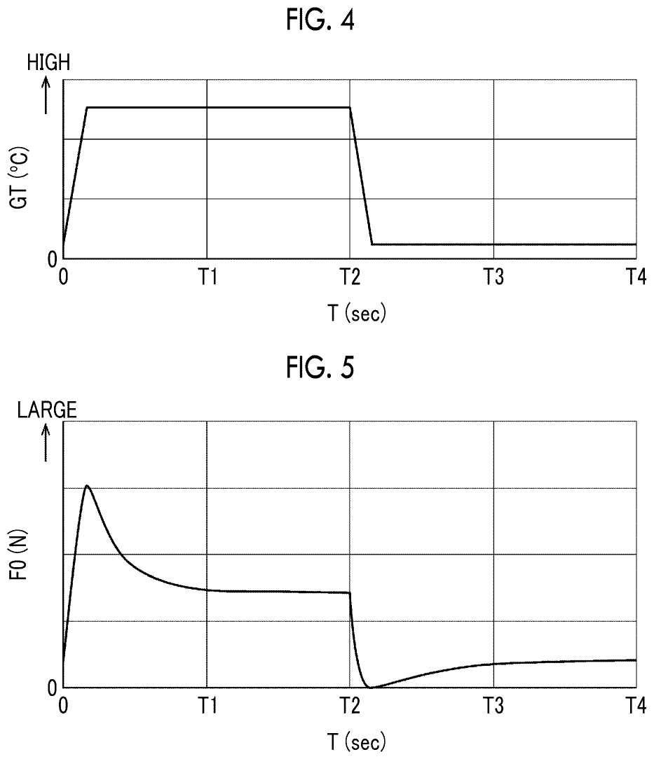

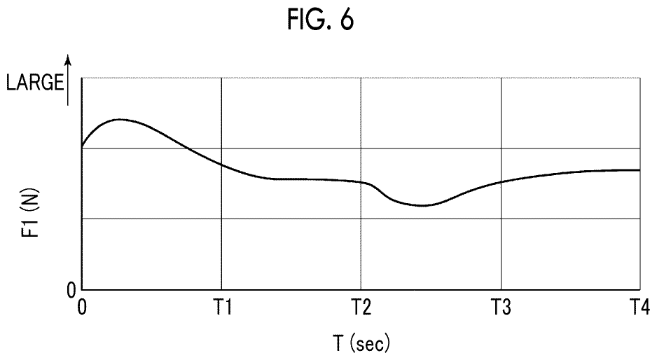

FIG. 4 is an explanatory diagram for explaining a temperature change of the working fluid that is introduced into the turbine 2 according to one embodiment of the present disclosure. FIG. 5 is an explanatory diagram for explaining a change in the biasing force FO that is applied to the nozzle device 06 of the turbine 02 according to the comparative example. FIG. 6 is an explanatory diagram for explaining a change in the biasing force F1 that is applied to the nozzle device 6 of the turbine 2 according to one embodiment of the present disclosure. In FIGS. 4 to 6, a horizontal axis represents time T (T1 to T4). In FIG. 4, a vertical axis represents a temperature (inlet temperature) GT of the working fluid (gas) that is introduced into the turbine 2. In FIG. 5, a vertical axis represents the biasing force FO, and in FIG. 6, a vertical axis represents the biasing force F1.

As shown in FIG. 4, the temperature GT changes over time during the operation of the turbine 2, and there are a high-temperature time period in which the temperature GT is relatively high and a low-temperature time period in which the temperature GT is relatively low. In the turbine 02 according to the comparative example, as shown in FIG. 5, there is a concern that the biasing force FO may not effectively act when the temperature GT transitions from a high temperature to a low temperature. Since the nozzle device 06 cools earlier than the first housing 4, a gap between the nozzle ring 07 and the housing-side flow path surface 47 increases, and the spring force of the annular seal ring 09 may not act. In the turbine 2 described above, as shown in FIG. 6, the biasing force F1 continues to act during the operation of the turbine 2 including a time of transition of the temperature GT from a high temperature to a low temperature. Since the biasing force F1 acts, a clearance between the first housing 4 and the fixed nozzle vane 8 is reduced, and a clearance flow is reduced, so that the performance of the turbine 2 can be improved.

As shown in FIG. 1, the turbine 2 according to some embodiments includes the turbine wheel 3, the first housing 4, the second housing 5, the nozzle device 6, and the biasing member 9 described above.

According to the configuration described above, due to a structure in which the first plate portion 7 and the fixed nozzle vane 8 are supported by the biasing force F1 of the biasing member 9, the first plate portion 7 comes into contact with the second housing 5 having a relatively low temperature, and thus the occurrence of a temperature distribution in the first plate portion 7 can be suppressed. Therefore, the thermal stress occurring in the first plate portion 7 can be reduced. In addition, since the first plate portion 7 and the second housing 5 do not come into contact with each other, the inflow of heat from the first plate portion 7 to the second housing 5 can be suppressed. In this way, since a heat loss of the turbine 2 can be reduced, the high-temperature performance (thermal efficiency) of the turbine 2 can be improved.

In addition, according to the configuration described above, the biasing member 9 is disposed in the first space 42B where a temperature fluctuation during the operation of the turbine 2 is smaller than that in the gas flow path 42A and a relatively low temperature is maintained. Therefore, the temperature of the biasing member 9 can be maintained at a relatively low temperature. In this way, heat deformation (plastic deformation or creep deformation due to heat) of the biasing member 9 can be suppressed, and a reduction in the biasing force F1 of the biasing member 9 due to the heat deformation can be suppressed. Therefore, according to the turbine 2 including the configuration described above, the biasing force F1 of the biasing member 9 can continuously act on the first plate portion 7 and the fixed nozzle vane 8 during the operation of the turbine 2. Therefore, the first plate portion 7 and the fixed nozzle vane 8 can be continuously supported during the operation of the turbine 2.

In addition, according to the configuration described above, an area on which the biasing force F1 acts can be increased as compared with a case where the fixed nozzle vane 8 is directly biased by the biasing member 9. In this way, the biasing force F1 of the biasing member 9 can continuously and stably act on the fixed nozzle vane 8 during the operation of the turbine 2.

In the turbine 2 according to some embodiments, as shown in FIG. 1, the first housing 4 described above has the housing-side flow path surface 47 that is an abutment surface against which the end surface 821 of each of the plurality of fixed nozzle vanes 8 on a side opposite to the side of each of the plurality of fixed nozzle vanes 8 which is fixed to the first plate portion 7 abuts.

According to the configuration described above, the end surface 821 of the fixed nozzle vane 8 is brought into close contact with the housing-side flow path surface 47 of the first housing 4 by the biasing force F1 of the biasing member 9, and the gap in the axial direction between the fixed nozzle vane 8 and the first housing 4 is eliminated. In this way, a gas flow passing through the gap can be suppressed, and thus the performance of the turbine 2 can be improved. In addition, according to the configuration described above, the number of components of the turbine 2 can be reduced and the turbine 2 can be easily assembled as compared with a case where another member is interposed between the fixed nozzle vane 8 and the first housing 4. Therefore, the manufacturing cost of the turbine 2 can be reduced.

In the turbine 2 according to some embodiments, as shown in FIG. 1, the first plate portion 7 described above and each of the plurality of fixed nozzle vanes 8 described above are integrally formed. In this case, compared to a case where the first plate portion 7 and each of the plurality of fixed nozzle vanes 8 are separate bodies, the number of components of the turbine 2 can be reduced, and the turbine 2 can be easily assembled. Therefore, the manufacturing cost of the turbine 2 can be reduced.

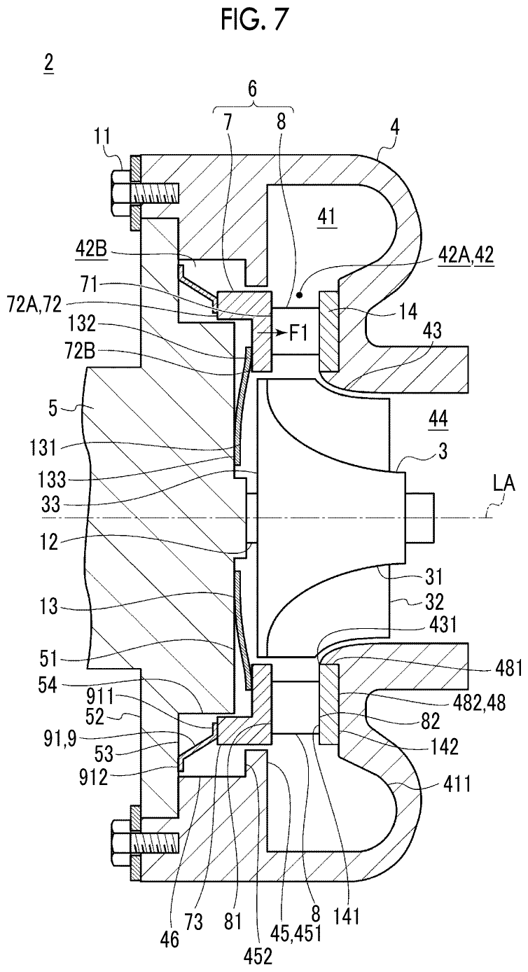

FIGS. 7 to 11 are schematic sectional views taken along the axis LA of the turbine 2 according to one embodiment of the present disclosure. The turbines 2 according to the embodiments shown in FIGS. 7 to 11 also exhibit the same operational effects as the operational effects described in the turbine 2 according to the embodiment shown in FIG. 1. The turbine 2 according to each of the embodiments shown in FIGS. 7 to 11 includes the turbine wheel 3, the first housing 4, the second housing 5, the nozzle device 6, and the biasing member 9 described above.

### Second Plate Portion

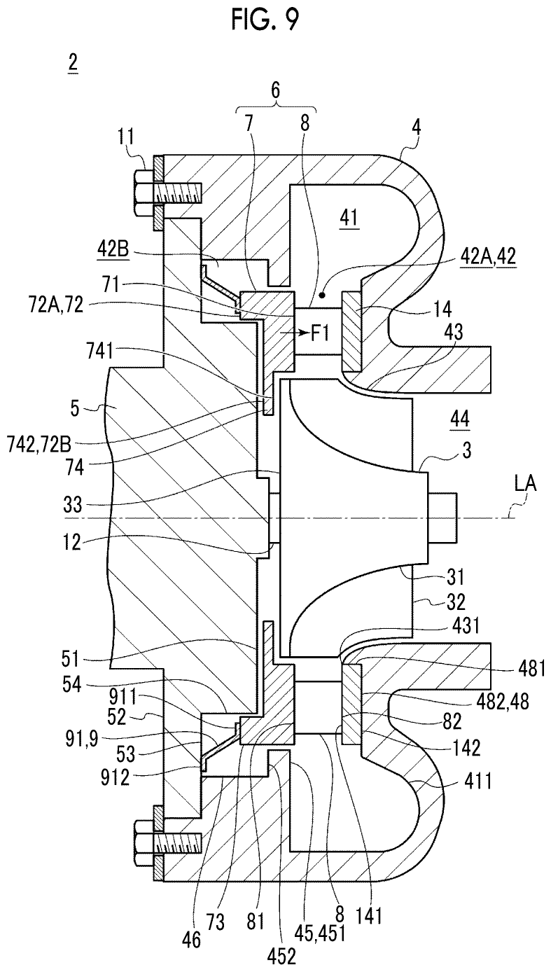

In the turbine 2 according to some embodiments, as shown in FIGS. 7 and 9, the nozzle device 6 described above further includes an annular second plate portion 14 extending along the circumferential direction. The second plate portion 14 has an annular second flow path surface 141 that faces the first flow path surface 71 with the gas flow path 42A interposed therebetween on one side in the thickness direction of the second plate portion 14, that is, on the rear side. The second plate portion 14 has an annular second back surface 142 on the other side (a side opposite to the second flow path surface 141) in the thickness direction of the second plate portion 14, that is, on the front side.

The end portion 82 on a side (front side) opposite to the end portion 81, which is a side of each of the plurality of fixed nozzle vanes 8 that is fixed to or supported by the first plate portion 7, is supported on or fixed to the second flow path surface 141. The second back surface 142 abuts against the first housing 4. The nozzle device 6 including the second plate portion 14 is supported between the biasing member 9 and the first housing 4 in the axial direction by the biasing force F1 of the biasing member 9.

In the illustrated embodiment, the first housing 4 is formed with an annular recessed portion 48 that is configured with an outer peripheral surface 481 extending from an outer peripheral end 431 of the shroud surface 43 to the front side along the axial direction, and an annular bottom surface 482 extending to the outer side along the radial direction from the front end of the outer peripheral surface 481. The second plate portion 14 is inserted into the recessed portion 48, and the second back surface 142 abuts against the bottom surface 482. The second plate portion 14 is inserted into the recessed portion 48, so that the second flow path surface 141 is connected to the outer peripheral end 431 of the shroud surface 43.

In the illustrated embodiment, the annular recessed portion 48 has a shape that does not limit the thermal elongation to the outer side in the radial direction due to the heat of the second plate portion 14. An outer peripheral end of the bottom surface 482 is connected to an inner peripheral end of a front-side scroll flow path surface 411 facing the front side of the scroll flow path 41.

According to the configuration described above, the fixed nozzle vane 8 is interposed between the first flow path surface 71 of the first plate portion 7 and the second flow path surface 141 of the second plate portion 14 by the biasing force F1 of the biasing member 9, and the gap in the axial direction between each of the first plate portion 7 and the second plate portion 14 and the fixed nozzle vane 8 is eliminated. In this way, a gas flow passing through the gap can be suppressed, and thus the performance of the turbine 2 can be improved. In addition, according to the configuration described above, compared to a case where the fixed nozzle vane 8 is in direct contact with the first housing 4, the influence of the thermal deformation of the first housing 4 on the gap in the axial direction can be reduced, and the occurrence of the gap in the axial direction can be more effectively suppressed. By eliminating the gap in the axial direction, a gas flow passing through the gap can be suppressed, and thus the performance of the turbine 2 can be improved.

In the turbine 2 according to some embodiments, as shown in FIGS. 7 and 9, the second plate portion 14 described above and each of the plurality of fixed nozzle vanes 8 described above are integrally formed. In the embodiments shown in FIGS. 7 and 9, each of the plurality of fixed nozzle vanes 8 is fixed to the second plate portion 14 by connecting the end portion 82 on the front side to the second flow path surface 141. Each of the plurality of fixed nozzle vanes 8 is supported by the first plate portion 7 with an end surface of the end portion 81 on the rear side abutting against the first flow path surface 71 and being biased by the biasing force F1.

According to the configuration described above, compared to a case where the second plate portion 14 and each of the plurality of fixed nozzle vanes 8 are separate bodies, the number of components of the turbine 2 can be reduced, and the turbine 2 can be easily assembled. Therefore, the manufacturing cost of the turbine 2 can be reduced.

In the embodiments shown in FIGS. 7, 9, and 11, the first plate portion 7 and each of the plurality of fixed nozzle vanes 8 described above may be integrally formed. In this case, each of the plurality of fixed nozzle vanes 8 is fixed to the first plate portion 7 by connecting the end portion 81 on the rear side to the first flow path surface 71. Each of the plurality of fixed nozzle vanes 8 is supported by the second plate portion 14 with the end surface 821 of the end portion 82 on the front side abutting against the second flow path surface 141 and being biased by the biasing force F1.

In the turbine 2 according to some embodiments, as shown in FIGS. 1 and 7, the above-described heat shielding member 13 having the first facing surface 131, the first plate portion-side abutment portion 132, and the second housing-side abutment portion 133 is provided. The gap that is formed between the first facing surface 131 and the back surface 33 of the turbine wheel 3 is not a minimum gap in which the first facing surface 131 and the back surface 33 are brought into non-contact with each other and the heat shielding member 13 can be disposed, but is a gap that can exhibit a heat shielding function to block heat transfer from the back surface 33 to the first facing surface 131.

According to the configuration described above, the heat shielding member 13 has a heat shielding function on the first facing surface 131 facing the back surface 33 of the turbine wheel 3 with a gap interposed therebetween. In this way, heat input to the first space 42B or the second housing 5 from the space facing the back surface 33 can be suppressed. In addition, since the heat shielding member 13 has the first plate portion-side abutment portion 132 that abuts against the first plate portion 7 on the outer periphery side with respect to the first facing surface 131 and the second housing-side abutment portion 133 that abuts against the second housing 5, the space facing the back surface 33 and the first space 42B can be partitioned, and the inflow of a gas having a relatively high temperature from the space facing the back surface 33 to the first space 42B can be suppressed. In this way, the heat input to the first space 42B or the second housing 5 from the space facing the back surface 33 can be further suppressed.

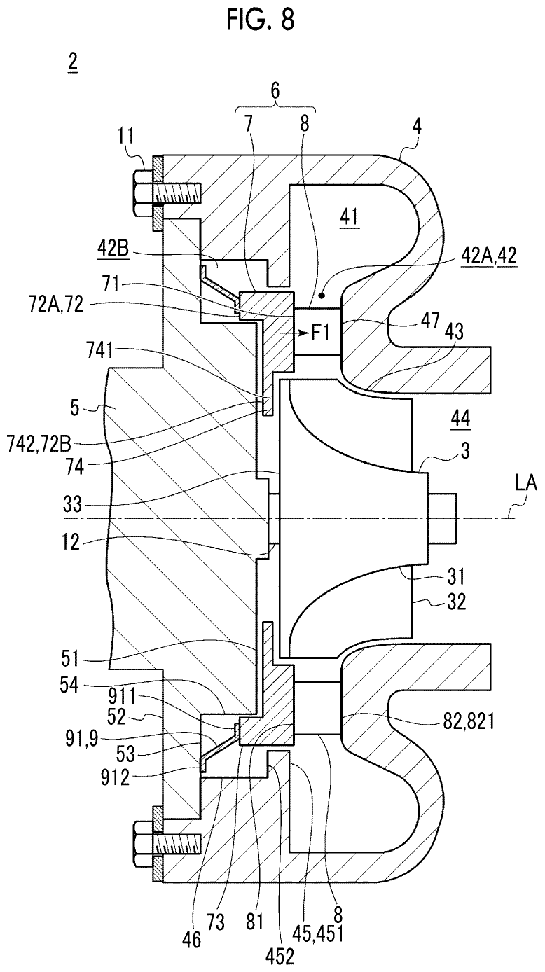

In the turbine 2 according to some embodiments, as shown in FIGS. 8 and 9, the first plate portion 7 described above has a first facing surface 741 facing the back surface 33 of the turbine wheel 3 with a gap interposed therebetween in the axial direction. The gap that is formed between the first facing surface 741 and the back surface 33 is not a minimum gap in which the first facing surface 741 and the back surface 33 are brought into non-contact with each other, but is a gap that can exhibit a heat shielding function to block heat transfer from the back surface 33 to the first facing surface 741.

In the illustrated embodiment, the first plate portion 7 has an annular heat shielding portion 74 that protrudes to the inner side in the radial direction with respect to the outer edge of the back surface 33. The first facing surface 741 is an annular surface formed on one side (the front side) in the thickness direction of the heat shielding portion 74, and an annular surface 742 formed on the other side (the rear side) in the thickness direction of the heat shielding portion 74 is a part of the first inner periphery-side back surface 72B described above.

According to the configuration described above, the first plate portion 7 can suppress the heat input to the first space 42B or the second housing 5 from the space facing the back surface 33 due to the first facing surface 741 facing the back surface 33 of the turbine wheel 3 with a gap interposed therebetween. Since the first plate portion 7 has a heat shielding function, a separate heat shielding member 13 does not need to be provided, and thus an increase in the number of components of the turbine 2 can be suppressed.

### Specific Example of Biasing Member

In the turbine 2 according to some embodiments, as shown in FIGS. 1 and 7 to 9, the biasing member 9 described above includes a disc spring 91. The disc spring 91 includes a first abutment portion 911 that abuts against the first back surface 72, and a second abutment portion 912 that abuts against the stepped surface 53, which is a surface facing the first space 42B of the second housing 5 on an outer periphery side with respect to the first abutment portion 911. The disc spring 91 is inclined to the rear side toward the second abutment portion 912 that is an outer peripheral end portion from the first abutment portion 911 that is an inner peripheral end portion. The disc spring 91 is configured to exert an elastic force along the axial direction. This elastic force acts as the biasing force F1 described above.

According to the configuration described above, the first plate portion 7 is biased by the elastic force of the disc spring 91 to bias the fixed nozzle vane 8 toward the first housing 4 side. By causing the relatively inexpensive disc spring 91 to exhibit the biasing function of biasing the first plate portion 7, it is possible to reduce the manufacturing cost of the turbine 2.

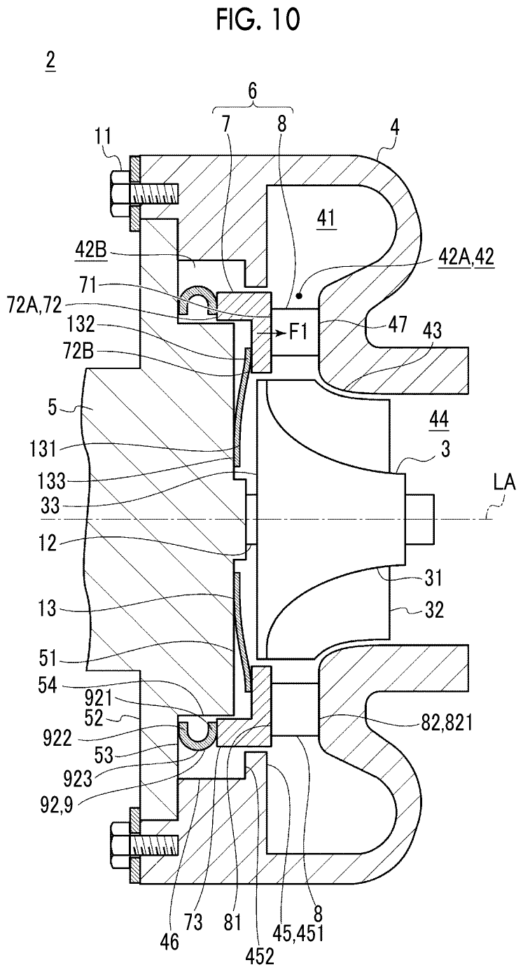

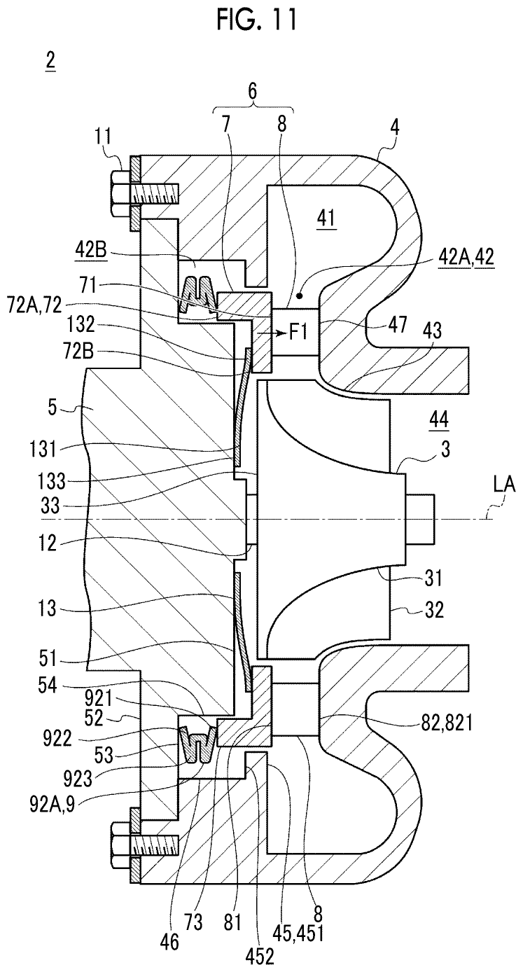

In the turbine 2 according to some embodiments, as shown in FIGS. 10 and 11, the biasing member 9 described above includes annular elastic seal members 92 and 92A. Each of the elastic seal members 92 and 92A includes a first biasing plate portion 921 that abuts against the first back surface 72, a second biasing plate portion 922 that abuts against the stepped surface (second facing surface) 53 of the second housing 5, and a connection portion 923 that connects outer peripheral end portions or inner peripheral end portions of the first biasing plate portion 921 and the second biasing plate portion 922 to each other.

In the embodiment shown in FIG. 10, the elastic seal member 92 is configured with a C-ring having a C-shaped cross-sectional shape. In the embodiment shown in FIG. 11, the elastic seal member 92A is configured with an E-ring having an E-shaped cross-sectional shape. The elastic seal members 92 and 92A are configured to exert an elastic force along the axial direction. This elastic force acts as the biasing force F1 described above.

According to the configuration described above, the first plate portion 7 is biased by the elastic force of each of the elastic seal members 92 and 92A to bias the fixed nozzle vane 8 to the first housing 4 side. By causing the relatively inexpensive elastic seal members 92 and 92A to exhibit the biasing function of biasing the first plate portion 7, it is possible to reduce the manufacturing cost of the turbine 2.

In some embodiments, as shown in FIGS. 10 and 11, the connection portion 923 described above connects the outer peripheral end portions of the first biasing plate portion 921 and the second biasing plate portion 922 to each other. In this case, since the inner diameter side of each of the elastic seal members 92 and 92A is open, in a case where the pressure on the radial inner side of the first space 42B with respect to each of the elastic seal members 92 and 92A is higher than the pressure on the radial outer side, the spring force of each of the elastic seal members 92 and 92A can be maintained due to a pressure difference.

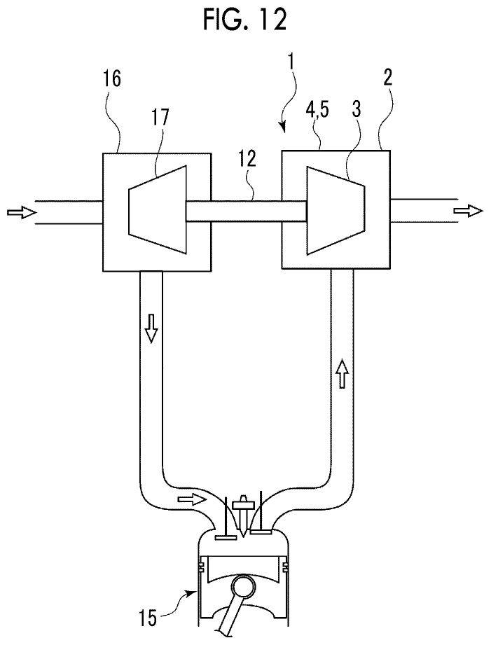

FIG. 12 is a schematic diagram of a turbocharger 1 according to one embodiment of the present disclosure. As shown in FIG. 12, the turbocharger 1 according to some embodiments includes the turbine 2 described above and a centrifugal compressor 16 configured to be driven by the turbine 2. The centrifugal compressor 16 includes a centrifugal compressor impeller 17, and the turbocharger 1 further includes the rotating shaft 12 in which the turbine wheel 3 is connected to one side and the compressor impeller 17 is connected to the other side. For example, the turbine wheel 3 is rotationally driven by the exhaust gas that is discharged from the engine 15. The compressor impeller 17 is rotationally driven in conjunction with the rotational drive of the turbine wheel 3, and is configured to compress a fluid such as air that is sent to the engine 15. According to the configuration described above, the reliability of the turbocharger 1 including the turbine 2 described above can be improved.

In the present specification, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous”, which indicate that things are in the same state, not only represent a state of being strictly equal, but also represent a state in which there is a tolerance, or a difference to the extent that the same function can be obtained.

Further, in the present specification, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Further, in the present specification, an expression such as “comprising”, “including”, or “having” one component is not an exclusive expression excluding the presence of another component.

The present disclosure is not limited to the embodiments described above, and includes modified forms of the embodiments described above or forms in which these embodiments are combined as appropriate.

The contents described in some embodiments described above are understood as follows, for example.

1) A turbine (2) according to at least one embodiment of the present disclosure includes:
a turbine wheel (3);
a first housing (4) having a scroll flow path (41);
a second housing (5) that is connected to the first housing (4), accommodates the turbine wheel (3) between the first housing (4) and the second housing (5), and forms a gas flow path (42A) from the scroll flow path (41) toward the turbine wheel (3) between the first housing (4) and the second housing (5);
a nozzle device (6) including at least
   an annular first plate portion (7) having a first flow path surface (71) facing the gas flow path (42A), and a first back surface (72) that is a surface on a side opposite to the first flow path surface (71) in an axial direction of the turbine wheel (3) and that forms a first space (42B) between the first housing (4) and the second housing (5), and
   at least one fixed nozzle vane (8) fixed to or supported by the first plate portion (7) and extending along the axial direction in the gas flow path (42A); and
a biasing member (9) disposed in the first space (42B) and configured to bias the at least one fixed nozzle vane (8) toward the first housing (4) side via the first plate portion (7).

According to the configuration of the above 1), due to a structure in which the first plate portion (7) and the fixed nozzle vane (8) are supported by the biasing force (F1) of the biasing member (9), the first plate portion (7) comes into contact with the second housing (5) having a relatively low temperature, and thus it is possible to suppress the occurrence of a temperature distribution in the first plate portion (7). Therefore, the thermal stress occurring in the first plate portion (7) can be reduced. In addition, since the first plate portion (7) and the second housing (5) do not come into contact with each other, the inflow of heat from the first plate portion (7) to the second housing (5) can be suppressed. In this way, since a heat loss of the turbine (2) can be reduced, the high-temperature performance (thermal efficiency) of the turbine (2) can be improved.

In addition, according to the configuration of the above 1), the biasing member (9) is disposed in the first space (42B) where a temperature fluctuation during the operation of the turbine (2) is smaller than that in the gas flow path (42A) and a relatively low temperature is maintained. Therefore, the temperature of the biasing member (9) can be maintained at a relatively low temperature. In this way, the heat deformation (plastic deformation or creep deformation due to heat) of the biasing member (9) can be suppressed, and a reduction in the biasing force (F1) of the biasing member (9) due to the heat deformation can be suppressed. Therefore, according to the turbine (2) including the configuration of the above 1), the biasing force (F1) of the biasing member (9) can continuously act on the first plate portion (7) and the fixed nozzle vane (8) during the operation of the turbine (2). Therefore, the first plate portion (7) and the fixed nozzle vane (8) can be continuously supported during the operation of the turbine (2).

2) In some embodiments, in the turbine (2) according to the above 1),
the first housing (4) has an abutment surface (a housing-side flow path surface 47) against which an end surface (821) of the at least one fixed nozzle vane (8) on a side opposite to a side of the at least one fixed nozzle vane (8) that is fixed to the first plate portion (7) abuts.

According to the configuration of the above 2), the end surface (821) of the fixed nozzle vane (8) is brought into close contact with the abutment surface (47) of the first housing (4) by the biasing force (F1) of the biasing member (9), and the gap in the axial direction between the fixed nozzle vane (8) and the first housing (4) is eliminated. In this way, a gas flow passing through the gap can be suppressed, and thus the performance of the turbine (2) can be improved. In addition, according to the configuration of the above 2), the number of components of the turbine (2) can be reduced as compared with a case where another member is interposed between the fixed nozzle vane (8) and the first housing (4), and the turbine (2) can be easily assembled. Therefore, the manufacturing cost of the turbine (2) can be reduced.

3) In some embodiments, in the turbine (2) according to the above 1), the nozzle device (6) further includes
an annular second plate portion (14) having a second flow path surface (141) that faces the first flow path surface (71) with the gas flow path (42A) interposed therebetween, and to which a side opposite to a side of the at least one fixed nozzle vane (8) that is fixed to or supported by the first plate portion (7) is supported or fixed, and a second back surface (142) that is a surface on a side opposite to the second flow path surface (141) in the axial direction and that is a surface abutting against the first housing (4).

According to the configuration of the above 3), the fixed nozzle vane (8) is interposed between the first flow path surface (71) of the first plate portion (7) and the second flow path surface (141) of the second plate portion (14) by the biasing force (F1) of the biasing member (9), and the gap in the axial direction between each of the first plate portion (7) and the second plate portion (14) and the fixed nozzle vane (8) is eliminated. In this way, a gas flow passing through the gap can be suppressed, and thus the performance of the turbine (2) can be improved. In addition, according to the configuration of the above 3), the influence of the thermal deformation of the first housing (4) on the gap in the axial direction can be reduced as compared with a case where the fixed nozzle vane (8) is in direct contact with the first housing (4), and the occurrence of the gap in the axial direction can be more effectively suppressed. By eliminating the gap in the axial direction, a gas flow passing through the gap can be suppressed, and thus the performance of the turbine (2) can be improved.

4) In some embodiments, in the turbine (2) according to the above 2),
the first plate portion (7) and the at least one fixed nozzle vane (8) are integrally formed.

According to the configuration of the above 4), the number of components of the turbine (2) can be reduced and the turbine (2) can be easily assembled as compared with a case where the first plate portion (7) and the fixed nozzle vane (8) are separate bodies. Therefore, the manufacturing cost of the turbine (2) can be reduced.

5) In some embodiments, in the turbine (2) according to the above 3),
the second plate portion (14) and the at least one fixed nozzle vane (8) are integrally formed.

According to the configuration of the above 5), the number of components of the turbine (2) can be reduced and the turbine (2) can be easily assembled as compared with a case where the second plate portion (14) and the fixed nozzle vane (8) are separate bodies. Therefore, the manufacturing cost of the turbine (2) can be reduced.

6) In some embodiments, the turbine (2) according to any one of the above 1) to 5) further includes:
a heat shielding member (13) having a first facing surface (131) facing a back surface (33) of the turbine wheel (3) with a gap interposed therebetween in the axial direction, a first plate portion-side abutment portion (132) that abuts against the first plate portion (7) on an outer periphery side with respect to the first facing surface (131), and a second housing-side abutment portion (133) that abuts against the second housing (5).

According to the configuration of the above 6), the heat shielding member (13) has a heat shielding function on the first facing surface (131) facing the back surface (33) of the turbine wheel (3) with a gap interposed therebetween. In this way, heat input to the first space (42B) or the second housing (5) from the space facing the back surface (33) of the turbine wheel (3) can be suppressed. In addition, since the heat shielding member (13) has the first plate portion-side abutment portion (132) that abuts against the first plate portion (7) on the outer periphery side with respect to the first facing surface (131) and the second housing-side abutment portion (133) that abuts against the second housing (5), the space facing the back surface (33) of the turbine wheel (3) and the first space (42B) can be partitioned, and the inflow of a gas having a relatively high temperature from the space to the first space (42B) can be suppressed. In this way, the heat input from the space to the first space (42B) or the second housing (5) can be further suppressed.

7) In some embodiments, in the turbine (2) according to any one of the above 1) to 5),
the first plate portion (7) has a first facing surface (741) facing a back surface (33) of the turbine wheel (3) with a gap interposed therebetween in the axial direction.

According to the configuration of the above 7), the first plate portion (7) can suppress the heat input to the first space (42B) or the second housing (5) from the space facing the back surface (33) of the turbine wheel (3) by the first facing surface (741) facing the back surface (33) of the turbine wheel (3) with a gap interposed therebetween. Since the first plate portion (7) has a heat shielding function, a separate heat shielding member (13) does not need to be provided, and thus an increase in the number of components of the turbine (2) can be suppressed.

8) In some embodiments, in the turbine (2) according to any one of the above 1) to 7),
the biasing member (9) includes
a disc spring (91) including
   a first abutment portion (911) that abuts against the first back surface (72), and
   a second abutment portion (912) that abuts against a surface of the second housing (5) facing the first space (42B) on an outer periphery side with respect to the first abutment portion (911).

According to the configuration of the above 8), the first plate portion (7) is biased by the elastic force of the disc spring (91) to bias the fixed nozzle vane (8) toward the first housing (4) side. By causing the relatively inexpensive disc spring (91) to exhibit the biasing function of biasing the first plate portion (7), it is possible to reduce the manufacturing cost of the turbine (2).

9) In some embodiments, in the turbine (2) according to any one of the above 1) to 7),
the second housing (5) has a second facing surface (a stepped surface 53) facing the first back surface (72) with a gap interposed therebetween, and
the biasing member (9) includes
an annular elastic seal member (92, 92A) including
   a first biasing plate portion (921) that abuts against the first back surface (72),
   a second biasing plate portion (922) that abuts against the second facing surface (53) of the second housing (5), and
   a connection portion (923) that connects outer peripheral end portions or inner peripheral end portions of the first biasing plate portion (921) and the second biasing plate portion (922) to each other.

According to the configuration of the above 9), the first plate portion (7) is biased by the elastic force of the elastic seal member (92, 92A) to bias the fixed nozzle vane (8) toward the first housing (4) side. By causing the relatively inexpensive elastic seal member (92, 92A) to exhibit the biasing function of biasing the first plate portion (7), it is possible to reduce the manufacturing cost of the turbine (2).

10) A turbocharger (1) according to at least one embodiment of the present disclosure includes
the turbine (2) according to any one of the above 1) to 9); and a centrifugal compressor (16) configured to be driven by the turbine (2).

According to the configuration of the above 10), it is possible to improve the reliability of the turbocharger (1) including the turbine (2).

### Reference Signs List

1: turbocharger
2, 02: turbine
3: turbine wheel
4: first housing
5: second housing
6, 06: nozzle device
07: nozzle ring
7: first plate portion
8: fixed nozzle vane
09: seal ring
9: biasing member
12: rotating shaft
13: heat shielding member
14: second plate portion
15: engine
16: centrifugal compressor
17: compressor impeller
31: hub
32: turbine blade
33: back surface
41: scroll flow path
42: internal space
42A: gas flow path
42B: first space
43: shroud surface
44: gas discharge flow path
45: inward protrusion portion
47: housing-side flow path surface
48: recessed portion
51: end surface
52: outward protrusion portion
53: stepped surface
71, 071: first flow path surface
72, 072: first back surface
72A: first outer periphery-side back surface
72B: first inner periphery-side back surface
73: protrusion portion
073: outer peripheral end portion
131: first facing surface
132: first plate portion-side abutment portion
133: second housing-side abutment portion
141: second flow path surface
142: second back surface
A: axial center
FO, F1: biasing force
GT: temperature
LA: axis
T: time
VC1: outer periphery-side virtual circle
VC2: inner periphery-side virtual circle

1. A turbine comprising:
a turbine wheel;
a first housing having a scroll flow path;
a second housing that is connected to the first housing, accommodates the turbine wheel between the first housing and the second housing, and forms a gas flow path from the scroll flow path toward the turbine wheel between the first housing and the second housing;
a nozzle device including at least
an annular first plate portion having a first flow path surface facing the gas flow path, and a first back surface that is a surface on a side opposite to the first flow path surface in an axial direction of the turbine wheel and that forms a first space between the first housing and the second housing, and
at least one fixed nozzle vane fixed to or supported by the first plate portion and extending along the axial direction in the gas flow path; and
a biasing member disposed in the first space and configured to bias the at least one fixed nozzle vane toward a first housing side via the first plate portion.

2. The turbine according to claim 1,
wherein the first housing has an abutment surface against which an end surface of the at least one fixed nozzle vane on a side opposite to a side of the at least one fixed nozzle vane that is fixed to the first plate portion abuts.

3. The turbine according to claim 1,
wherein the nozzle device further includes
an annular second plate portion having a second flow path surface that faces the first flow path surface with the gas flow path interposed therebetween, and to which a side opposite to a side of the at least one fixed nozzle vane that is fixed to or supported by the first plate portion is supported or fixed, and a second back surface that is a surface on a side opposite to the second flow path surface in the axial direction and that is a surface abutting against the first housing.

4. The turbine according to claim 2,
wherein the first plate portion and the at least one fixed nozzle vane are integrally formed.

5. The turbine according to claim 3,
wherein the second plate portion and the at least one fixed nozzle vane are integrally formed.

6. The turbine according to claim 1, further comprising:
a heat shielding member having a first facing surface facing a back surface of the turbine wheel with a gap interposed therebetween in the axial direction, a first plate portion-side abutment portion that abuts against the first plate portion on an outer periphery side with respect to the first facing surface, and a second housing-side abutment portion that abuts against the second housing.

7. The turbine according to claim 1,
wherein the first plate portion has a first facing surface facing a back surface of the turbine wheel with a gap interposed therebetween in the axial direction.

8. The turbine according to claim 1,
wherein the biasing member includes
a disc spring including
a first abutment portion that abuts against the first back surface, and
a second abutment portion that abuts against a surface of the second housing facing the first space on an outer periphery side with respect to the first abutment portion.

9. The turbine according to claim 1,
wherein the second housing has a second facing surface facing the first back surface with a gap interposed therebetween, and
the biasing member includes
an annular elastic seal member including
a first biasing plate portion that abuts against the first back surface,
a second biasing plate portion that abuts against the second facing surface of the second housing, and
a connection portion that connects outer peripheral end portions or inner peripheral end portions of the first biasing plate portion and the second biasing plate portion to each other.

10. A turbocharger comprising:
the turbine according to claim 1; and
a centrifugal compressor configured to be driven by the turbine.
